(19) United States
(12) Patent Application Publication
(10) Pub. No.: US 2011/0010187 A1
(43) Pub. Date: Jan. 13, 2011

(54) METHOD AND SYSTEM FOR PLANNING A MEDICAL PROCEDURE AND GENERATING DATA RELATED TO SAID MEDICAL PROCEDURE

(75) Inventors: Matts Andersson, Lerum (SE); Timo Kero, Goteborg (SE); Lina Odhe, Goteborg (SE)

Correspondence Address: KNOBBE MARTENS OLSON & BEAR LLP, 2040 MAIN STREET, FOURTEENTH FLOOR, IRVINE, CA, 92614, US

(73) Assignee: NOBEL BIOCARE SERVICES AG, Zurich (CH)

(21) Appl. No.: 12/678,137

(22) PCT Filed: Sep. 12, 2008
(86) PCT No.: PCT/EP2008/007469

§ 371 Date: Sep. 16, 2010

(30) Foreign Application Priority Data
Sep. 12, 2007 (SE) 0702025-8

(51) Int. Cl. G06Q 50/00

(52) U.S. Cl. 705/2

(57) ABSTRACT

A computer-implemented method comprising virtual planning a medical procedure of a patient and/or generating data based on said virtual planning for subsequent use in production of a medical product devised for use in said medical procedure. The method comprises variation simulating a virtual assembly process of the medical procedure. In this manner robustness of the medical procedure is improved.

### CROSS-REFERENCE TO RELATED APPLICATIONS

This application is a national stage application under 35 U.S.C. §371 of PCT Application No. PCT/EP2008/007469 designating the United States, filed on Sep. 12, 2008. The PCT Application was published in English, as WO 2009/033677 A2 on Mar. 19, 2009, and claims the benefit of the earlier filing date of Swedish Patent Application No. 0702025.8, filed Sep. 12, 2007. The contents of PCT Application No. PCT/EP2008/007469, including publication WO 2009/033677 A2, and Swedish Patent Application No. 0702025.8, are incorporated herein by reference in their entirety.

### BACKGROUND

1. Field of the Invention

This invention pertains in general to the field of medical procedures and related products. More particularly the invention relates to computer based planning of such medical procedures comprising an assembly process, as for instance guided surgery, such as surgical template based dental drill guided and/or implant guided surgery.

2. Description of the Related Art

Modern medical rehabilitation applies in many medical fields an industrially oriented manufacturing process, where many technologies and activities are performed to accomplish the intended purpose.

An example is Computer-aided design (CAD) and Computer-aided manufacture (CAM) that have evolved since the 1970's. Firstly, space industry has taken advantage of these methods. Since the beginning of the 1980's CAD and CAM have entered the field of medical products and revolutionized this field.

A pioneer within dentistry, who introduced CAD/CAM methods in the early 1980's is Dr. Francois Duret, a French dentist. For instance EP0091876A1, published in 1983, or EP0110797A1, published in 1984, both of Dr. Duret, disclose a device for taking impressions by optical means for the automatic shaping of dental prostheses. For instance crowns, inlays or dentures are produced automatically based upon an optical impression taken of the oral region with nontraumatic radiation. Reflected waves are transformed into numerical data which is used directly to operate a CAM machine in a dental fabrication process.

For instance WO9844865, of the same applicant as the present application, discloses an arrangement used at an operating site to assemble individual dental products. The operating site is provided with computer equipment which can reproduce a simulated model of the jaw, dentine, implant, etc., and structural elements applied to the model. The operating site is arranged to collate data in a query profile relating to part of the assembly. The query profile data is transmitted via a network to a central unit and further to a manufacturing site that is connected to the central unit for production of the dental products. The dental products are then sent to the operating site where they are installed in the patient.

Thus mass customized dental products are provided in an industrialized process where rehabilitation is pre-prepared and pre-planned. This allows for instance to minimize the actual time for the rehabilitation, to enable treatments that have not been possible before or were difficult to achieve, to minimize the proportion of the surgery and to make surgeries safer.

However, such advantageous mass customized products, such as medical implants or dental restorations and related products, require many adjustable parameters both during planning of the medical procedure and planning and manufacturing of corresponding medical products that are to be used during these medical procedures. Thus, such mass customized industrial processes are difficult to handle, at least from a cost effectiveness perspective.

In addition, there has been a lack of analytical methods for optimizing the planning and/or production of devices related to the medical treatment, when faced with mass customized products.

Hence, within the medical field there is a need for improving mass customizing methods, for instance with regard to reliability of implants, patient safety, cost for manufacture and/or treatment.

Hence, an improved method and/or system for medical treatment, planning and/or production of products related to the medical treatment, would be advantageous and in particular allowing for increased flexibility, cost-effectiveness, reliability, patient safety and/or patient satisfaction would be advantageous.

### SUMMARY

Accordingly, embodiments of the present invention preferably seek to mitigate, alleviate or eliminate one or more deficiencies, disadvantages or issues in the art, such as the above-identified, singly or in any combination by providing a method, a system, a computer program, and a medical workstation according to the appended patent claims.

According to a first aspect of the invention, a method is provided. The method is a computer-implemented method and comprises virtual planning of a medical procedure of a patient, wherein the medical procedure comprises an assembly process. Further, the method comprises generating data based on the virtual planning, wherein the data is configured for subsequent use in production of a medical product, which medical product is devised for use in the medical procedure, and/or for controlling a device configured to facilitate the medical procedure. Moreover, the method comprises variation simulating a virtual assembly process corresponding to the assembly process of the medical procedure.

The method may provide for simplifying, helping, aiding, sustaining, supporting, facilitating, expediting, assisting, implementing and/or enabling the medical procedure including the assembly process thereof and/or production of the medical product.

According to a second aspect of the invention, a system is provided. The system is a system for implementing the method according the first aspect of the invention and comprises a unit for virtual planning of a medical procedure of a patient, which medical procedure comprises an assembly process; and a unit for generating data based on the virtual planning, wherein the data is configured for subsequent use in production of a medical product, which medical product is devised for use in the medical procedure, and/or for controlling a device configured to facilitate the medical procedure; and a unit for variation simulating at least a virtual assembly process at least partly corresponding to the assembly process of the medical procedure.

According to a third aspect of the invention, a computer program for processing by a computer is provided. The computer program enables carrying out of the method according to the first aspect of the invention by a computer. The computer program comprises a first code segment for virtual planning of a medical procedure of a patient, which medical procedure comprises an assembly process; and a second code segment for generating data based on the virtual planning, wherein the data is configured for subsequent use in production of a medical product, which medical product is devised for use in the medical procedure, and/or for controlling a device configured to facilitate the medical procedure; and a third code segment for variation simulating at least a virtual assembly process at least partly corresponding to the assembly process of the medical procedure.

According to still a further aspect of the invention a graphical user interface for virtual planning an assembly process of a medical product in a patient is provided. The graphical user interface comprises an indicator for the robustness of the assembly process.

According to yet a further aspect of the invention a medical workstation is provided. The medical workstation is devised for executing the computer program according to the third aspect of the invention and comprises a unit for virtual planning a medical procedure of a patient and/or generating data based on the virtual planning for subsequent use in production of a medical product devised for use in the medical procedure, the medical workstation comprising a unit for variation simulating a virtual assembly process of the medical procedure.

According to still a further aspect of the invention a graphical user interface for virtual planning an assembly process of a medical product in a patient is provided. The graphical user interface comprises an indicator for the robustness of the assembly process.

Further embodiments of the invention are defined in the dependent claims, wherein features for the second and subsequent aspects of the invention are as for the first aspect mutatis mutandis.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 is a schematical illustration of geometrical variation contributors in surgical template based dental drill guided and/or implant guided surgery;

FIG. 2 is a flow chart illustrating a method according to an embodiment;

FIGS. 3A to 3D are schematic illustrations of various stages of a step of a variation simulation of an installation of dental implants with surgical template based dental drill guided and/or implant guided surgery in a maxilla (upper jaw) of a patient;

FIGS. 4A and 4B are schematic illustrations of spherical or planar variance simulations of a Monte Carlo simulation;

FIG. 5 is a is a schematic illustration of from top to bottom of the Figure progressively increasing numbers of Monte Carlo variance simulations of positions of a dental implant;

FIGS. 6A, 6B, 6C are graphs showing statistical variance distributions of an apical part of an implant in x-direction, y-direction, and z-direction respectively;

FIG. 7 is a schematic illustration of a result of a variance simulation of a virtually planned dental drill guided and implant guided surgery in a maxilla;

FIG. 8A is a schematical illustration of a variation simulation of a planning of a dental restoration comprising a coping on a dental preparation;

FIG. 8B is a graph in a schematic illustration showing a statistical variance distribution of a point of the coping of FIG. 8A; FIG. 8C is a schematical illustration showing increasing numbers (from i, ii, iii, iv, to v) of Monte Carlo variance simulations of positions of the coping of FIG. 8A;

FIG. 9 is a schematical illustration of a general locating scheme;

FIG. 10 is a schematical illustration of a locating scheme in a dental drill guided and/or implant guided surgery;

FIG. 11 is a schematic illustration of a system according to an embodiment; and

FIG. 12 is a schematic illustration of a computer program according to an embodiment.

### DETAILED DESCRIPTION

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

The following description focuses on embodiments applicable to planning a surgical template based dental drill guided and/or implant guided surgery. However, it will be appreciated that the invention is not limited to this application but may in embodiments be applied to many other medical procedures, such as replacement of body portions, such as joints with implants, as for instance hip implants, knee joint implants, artificial or replacement vertebrae, artificial shoulder implants, artificial joint replacement implants, or in various other medical treatments and procedures, such as within framebased or frameless stereotactic surgery.

The focus of medical procedures has previously often been the minimization of the actual time needed for the medical procedure, such as a surgical procedure, enabling medical procedures that have not been possible earlier or difficult to achieve, minimizing the proportion of the medical procedure, and/or to make surgeries safer. However, to provide a measure for the robustness of a planned medical procedure, before the procedure actually is performed, has not been provided hitherto. Embodiments of the present invention provide for this.

More precisely, some embodiments of the invention provide for an advantageous verification of an intended or virtually planned medical procedure before the actual medical procedure is performed. Thus robustness of the medical procedure and a concept of the medical products used in the medical procedure may be improved and/or optimized during a virtual planning stage thereof.

For instance medical procedures within guided surgeries are becoming common in modern dental industry, and are used for a variety of treatments, such as described in PCT/SE2002/002393 of the same applicant as the present application, which is incorporated herein by reference in its entirety. In PCT/SE2002/002393 a surgical template based dental drill guided and/or implant guided surgery concept is disclosed. Embodiments of the invention provide for improved medical procedures, such as surgical template based dental drill guided and/or implant guided surgery by—facilitating a virtual prognosis, verification, and/or redesign of the design concept and/or an assembly process of the medical procedure.

The medical procedure comprises an assembly process, which in itself may comprise a plurality of sub-assembly processes.

According to embodiments of the invention, a variation simulation is performed, e.g. in order to predict final positions of a medical product, such as a dental restorative product, in a patient. For instance a robustness of a dental restoration is in this manner determined prior to the actual medical procedure. This allows to investigate pre-defined critical product dimensions, e.g. at an apical part of a dental implant, also called fixture.

Below, a method for virtual simulation of surgical template based dental drill guided and/or implant guided surgery is described in some embodiments. A virtual simulation of a surgical template based dental drill guided and/or implant guided surgery is provided, wherein the virtually pre-planned surgery verifiable before the actual surgery.

The surgical template based dental drill guided and/or implant guided surgery concept is a planning and surgical implementation system that enables surgery with the help of a drill guide, called surgical template. The concept is based on planning supported by computer aided design tools and patient input data, e.g. derived from a CT-scan, a touch probe scan, an optical scan, a holographic scan, an MR scan, an X-Ray, or a combination thereof.

Surgical template based dental drill guided and/or implant guided surgery comprises a virtual planning of this medical procedure. A surgical template enables the transfer of the planning to a real medical procedure performed in the mouth.

In the latter case the above-mentioned medical procedure is a surgical template based dental drill guided and/or implant guided surgery. The surgical template based dental drill guided and/or implant guided surgery may comprise in itself a plurality of sub-assemblies, such as affixing the surgical template to the patient, drilling one or more holes in a guided manner by means of the surgical template that is affixed to the patient, screwing one or more dental implants in the previously drilled one or more holes, respectively, etc.

Rapid prototyping is used for manufacturing the surgical template, which consequently is a mass customized product. Each surgical template is specific for a specific dental situation of a patient. The rapid prototyping is based on reverse engineering of anatomical structures of the craniooral portion of the patient's body. Rapid prototyping allows the design of three-dimensional models of anatomical structures and medical products related thereto. Within rapid prototyping input data is based on the above-mentioned patient input data, namely scan data of the craniooral portion. The scan data may for instance be provided from imaging modalities, such as computer tomography (CT), magnetic resonance (MR), X-ray, or 3D scanners, such as touch probe scanners or optical scanners. As each drill- and implant-guide is patient specific, production specifications have to be altered each time a new medical product is produced. This means that a new requirement specification is set up each time a new patient specific product is manufactured. There is a need to provide an optimal product each time for each surgery performed on patients. Consequently, there is a need for providing a tool that contributes to ensuring this goal. Embodiments of the present invention satisfy this need.

As just mentioned above, production systems with mass customization flexibility place high requirements on the production process, considering both software and hardware. From a general point of view within the medical area, precision and accuracy is of high interest. This is due to patient safety. Therefore, it is also of high interest to optimize the assembly processes in a geometrical variation-suppressing way. In other words, a treatment that is always nominal is desirable regarding patient safety yet it is not possible, due to variation throughout the treatment concept.

Further below, embodiments are described that relate to a method that enables to determine where to set an emphasis for process optimization regarding the minimization of geometrical variation of a medical product devised for use in a medical procedure comprising an assembly process.

Additionally, or alternatively in embodiments it is determined where a source of the most sensitive parameter for a medical procedure is located in the assembly process. This is called sensitivity analysis. This determination provides for a re-design of a design concept on which the medical procedure is based.

Additionally, or alternatively in embodiments it is determined which parameters contribute most to tolerances of the final result of the assembly process of the medical procedure. This is called contribution analysis. This determination provides for a re-design of the assembly process of the medical procedure.

Additionally, or alternatively, embodiments comprise verifying a planning of the medical procedure comprising an assembly process, e.g. based on the results of the aforementioned contribution analysis.

In some embodiments a virtual planning of a surgical template based dental drill guided and/or implant guided surgery is verified in order to predict a result of a predefined critical product dimension already in the pre-plan of the process. A variation simulation of a surgical template based dental drill guided and/or implant guided surgery is provided, whereby the planned surgical template based dental drill guided and/or implant guided surgery is also verified before the actual surgery. The rationale achieved by this embodiment is that well prepared dental surgery is essential for the outcome of the result.

In another embodiment, a dental restoration comprising a coping to be affixed to a dental preparation is described.

In an embodiment, a prediction of the results of a surgical template based dental drill guided and/or implant guided surgery may be performed. Furthermore, a contribution analysis may predict the greatest variation contributor in an assembly process of the medical procedure.

By means of variation simulation, it may be determined where it is most advantageous to focus on when an optimization of the assembly process needs to be made regarding geometrical variation. If an optimization of the assembly process is made, the assembly process also approaches a more robust design, suppressing variation. Thus the treatment performed converges towards a treatment that has improved patient safety.

Embodiments of the invention provide for pre-planned medical procedures that may be geometrically optimized since it is possible to predict the final result. Calculations were performed with the help of a toolkit that the applicant specifically developed, and which was run in an environment of the software RD&T. RD&T is software intended for variation simulation for assembly processes. The toolkit was developed for biomedical applications with a complex assembly process. Results of some calculations performed with reference to an example are given further below. In practice, this variation simulation tool provides safer treatments for the patients.

Variation afflicts all manufacturing processes, when considering both mass production and mass customization. This means that the nominal value of a product dimension may not be expected at all times.

If certain requirements of a medical treatment to be achieved are not met, a medical product used for the medical treatment may not comply with functional, aesthetic, geometrical and/or assembly requirements.

The surgical template based dental drill guided and/or implant guided surgery employs production processes, mass production, and mass customization. This means that the nominal value of a product dimension may not be expected at all times due to tolerances in the process. Instead, the product dimension may be described by a contribution factor, such as a tolerance thereof, e.g. described by an expected range and a statistical probability distribution of the product dimension.

For most processes, manufacturing costs rise with decreasing variation. This is the primary reason why design concepts with functionality based on small manufacturing variation should be avoided from an industrial perspective. Hence, this is something that has to be considered when assembling products, as in surgical template based dental drill guided and/or implant guided surgery, and when patient safety is in focus. Furthermore, in order to perform a guided surgery, meeting geometry requirements is fundamental to assure that the final product functions as planned and is of high quality. If the requirements are not met, the product may not comply with functional, aesthetic, geometrical and/or assembly demands.

For surgical template based dental drill guided and/or implant guided surgery, this may mean that implants do not fit the dental restoration as intended, for instance due to incorrect pre-preparation. This, in turn, could mean a loss of functionality, the dental restoration not fitting as intended or the implants penetrating through bone tissue or damaging nerves.

Due to different geometrical sensitivities in manufacturing complex products, variation in each production step requires optimization and the consideration of tolerance allocation. In the beginning of designing a concept, the production steps may be analyzed by means of a design dependency matrix. The design dependency matrix is based on an information flow between activities and participants in the process. The design dependency matrix may comprise the entire steps of the process in a timely sequence. Further, the design dependency matrix may comprise a value for at least one contribution factor of each process step. By means of the design dependency matrix, dependencies between the process steps are specified. In this manner, by going though the entire process, it may be provided how the contribution factors propagate in the process. For instance, the contribution factor may be a tolerance contributed by each process step. In this case, the design dependency matrix facilitates to identify how tolerances propagate in the process.

For instance, in surgical template based dental drill guided and/or implant guided surgery, the process steps may comprise a number of process steps performed by a clinician, such as making an impression of missing teeth, making an impression of an opposite jaw, creating an occlusal index, etc. These process steps each have a tolerance, e.g. by the dimension of an impression tray, the handling by the clinician, shrinkage of material used for taking the impression etc. The dental impression is delivered to the next participant in the process of creating the surgical template based dental drill guided and/or implant guided surgery, namely the dental technician. The dental technician produces a stone model of the missing teeth and a stone model of the opposite jaw, based on the impressions taken by the clinician. The two stone models are then registered in an articulator, etc. These further steps each have their own tolerance, add up with the tolerances of the previous steps on which they depend on. For instance, preparing the stone model of the missing teeth has a tolerance due to the shrinkage of the material used for making the stone model from the dental impression. This latter tolerance adds up with the tolerance of the dental impression, which is mentioned above. In the same manner, the tolerances of the impression of the opposite jaw and the stone model thereof add up, as well as the tolerance of the creating of the occlusal index and the registering in the articulator.

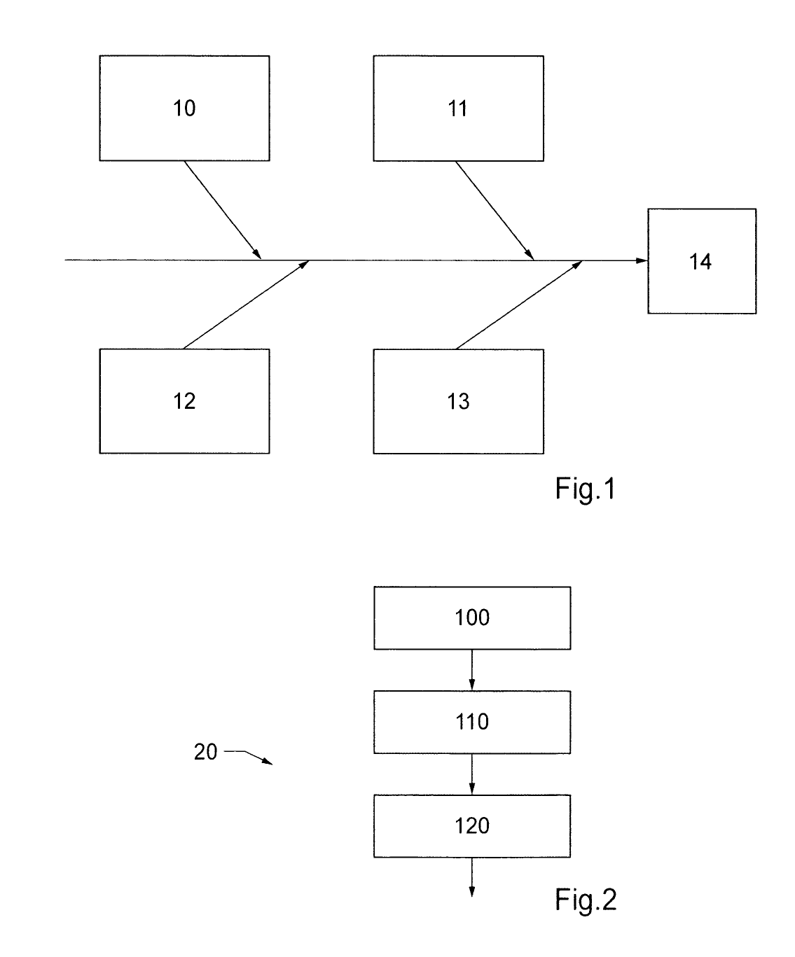

Geometrical variation in critical product dimensions may result from a number of different input parameters, as illustrated in FIG. 1. FIG. 1 presents a cause and effect diagram specific to surgical template based dental drill guided and/or implant guided surgery. In FIG. 1 contributions to the effect of surgical template based dental drill guided and/or implant guided surgery concepts are illustrated. In more detail, the categories of the effect—Part Variation 10, Design Concept 11, Examination of Patient 12, and Assembly Variation (Surgery) 13—are general effects, wherein the summarized effect is the final variation 14 in general surgical template based dental drill guided and/or implant guided surgery. Only the input parameters within each category 10, 11, 12, 13 differ between surgical template based dental drill guided and/or implant guided surgeries.

The sources of input parameters in surgical template based dental drill guided and/or implant guided surgery may for example comprise the following categories:

Part Variation 10:

Each of the surgical templates having an individual geometry, the anchor pins, the implants and the patient show part variation. The variation originates for instance from machine precision, process variation and the manufacturing process. Part variation, size and form variation in the geometry of the individual parts, originates from the individual manufacturing process used, which in addition varies over time. This input to the final variation may originate from the manufacturing process of e.g. the surgical template, the anchor pins, the dental implants, etc.

Examination of Patient 12:

Variation occurring during examination of the patient includes variation, for instance variation caused by the jaw impression, bite impression, and CT scanning of the patient. Taking a bite impression is exposed to tolerances, e.g. caused by patient movements during taking the impression, or tolerances of the material used, shrinkage of impression material used, etc. The variation contribution in this group not only involves material accuracy and the accuracy of the patient data scanner, but also the patient itself, e.g. small movements during the scanning and teeth occlusion. The variation of this group is a challenge to predict.

Assembly Variation 13, i.e. the Guided Surgery:

Variation occurring during the assembly process includes for instance assembly of the surgical template and installation of one or more dental implants, guided by the installed surgical template. The variation originates for instance from the design of the surgical template and the human factor during the operation. The variation may also originate from the manufacturing process, the assembly precision, and the process variation. Similarly, the assembly process during the medical procedure contributes to the final variation. Variations originate e.g. from variations in installing surgical templates, anchor pins, or dental implants in the patient.

Design Concept: 11

Variation of the design concept is for instance caused by variation of the scanned patient data due to converting variation, treatment planning and the scanner itself. The variation originates from the robustness of the design concept.

In addition, at least some of these variations contributing to the final variation may vary over time.

Some of these variation input parameters have more weight on the final variation than others. For instance, in the case of surgical template based dental drill guided and/or implant guided surgery, the position of the apical part of a dental implant is the most critical product dimension influencing the overall result of surgery. In other cases, the critical product dimension may be determined depending on other factors related to the assembly process and/or a production process of medical products related to the assembly process.

For example, the assembly process may comprise affixing a bridge to one or more dental implants, for instance after a healing period subsequent to the above case of surgical template based dental drill guided and/or implant guided surgery. In this case the critical product dimension may be the position of the connection interface of the dental implant towards the bridge. Again, in turn, the bridge itself may be a sub-assembly, as e.g. a milled bridge where the tolerance of a milling cutter has a tolerance, or e.g. a sintered bridge, where the sintering process has a tolerance. The tolerance of a sub-assembly contributes to the aggregate tolerance of the entire assembly process, e.g. affixing the bridge to the connection interface of the dental implant.

An important contributor to final variation is also the robustness of the design concept itself. A sensitive design concept amplifies part and assembly variation. A robust concept, on the other hand, suppresses variation.

When considering drill- and implant-guided surgery, the robustness of the concept is determined in two stages: firstly, when the concept is designed, and secondly, when placement of an anchoring system between the drill- and implant-guide and jaw is planned. This gives the process great flexibility to perform complex surgery. However, it also means that a control method regarding the flexibility of the system is required.

Different types of probability distributions may describe variation that occurs in a manufacturing process. Some probability distributions are uniform-, normal-, trapezoid-, and beta distribution. According to the central limit theorem, the sum of a plurality of distributions tends to be close to the normal distribution. For example, the tolerance in a machined part may be defined by the sum of a large number of infinitesimal effects. These may comprise the humidity, the cutting angle, fixturing variations, the variation in the material, and so on. If the component errors are independent and equally likely to be positive or negative, then the total error has an approximate normal distribution.

The means of managing variation and secure function, form and assembly, is by assigning tolerances that restrict the permitted variation of a geometrical feature. Thus tolerances may be allocated in a top-down fashion. There, overall product constraints are broken down into component constraints and, finally, into tolerances for individual geometrical features. This is a complex process, where functional and quality aspects must be balanced with manufacturing constraints and cost aspects.

In the concept phase, the product and the production concept are developed. Product concepts are analyzed and optimized to withstand the effect of manufacturing variation. They are also tested virtually against available production data. In this phase, the concept is optimized with respect to robustness, and verified against assumed

production systems by statistical tolerance analysis. Thus, the visual appearance of the product may be optimized, and product tolerances are allocated down to a part level.

In the verification and pre-production phase, the product and the production system are physically tested and verified. Adjustments are made to both product and production system to adjust errors and prepare for full production. In this phase, inspection preparation takes place. This is the activity in which all inspection strategies and inspection routines are decided.

In the production phase, all production process adjustments are completed, and the product is in full production. The focus in this phase is on controlling production and detecting and correcting errors.

In order to discover where to set the focus for process optimization regarding minimization of the geometrical variation and in order to find the most sensitive parameter of dental drill guided and/or implant guided surgery, a variation simulation, e.g. according to the Monte Carlo simulation method, of the surgery is made. Monte Carlo variance simulation provides statistical data for further processing.

### Monte Carlo Simulation

The fundamental theory for the variation simulation is that the calculation takes the geometrical key characteristics into consideration. In an embodiment, the Monte Carlo simulation method is used.

The Monte Carlo simulation method randomly generates numbers for all input parameters according to defined distributions and builds up distributions for the output parameters, i.e. the critical product dimensions.

The Monte Carlo simulation is performed a certain number of iterations. After a number of iterations the results of a Monte Carlos simulation converge towards a stable solution. For instance, the simulation of a guided surgery assembly approximately 100,000 Monte Carlo iterations are sufficient for the results to converge towards a stable solution, regarding the third decimal number of the results. However, also other number of iterations may be needed or sufficient. A range of about 5000 to 100000 iterations is a practical range where the iterations converge to an identical solution and the simulation may be aborted.

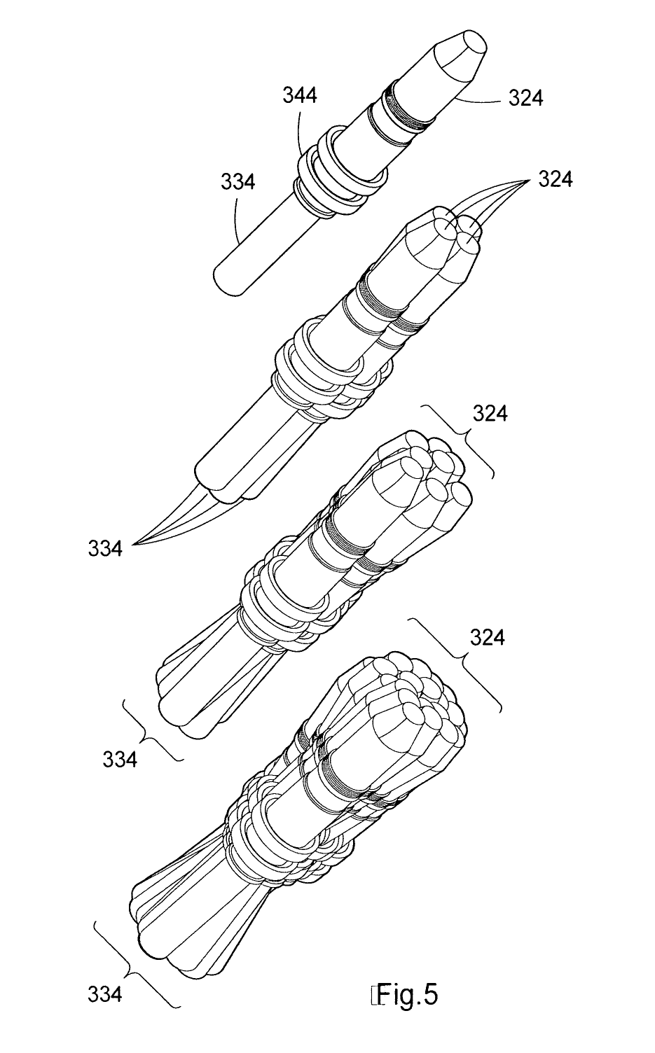

The number of iterations may be illustrated with a volume, such as illustrated in FIG. 5, illustrating increasing numbers of iterations from top to bottom of the Figure. Each iteration contributes with an end position at the end of the simulated assembly process, which is specific for that iteration. It may be the same or different than the end position determined in earlier iterations. The more iterations are made, the larger the total volume occupied by the cumulative volumes gets due to the tolerances in the system. The illustration in FIG. 5 is not to scale and exaggerated for illustrative purposes. In practical implementations, the volume increase of the cumulative volume may have such small dimensions that it may not be seen with the eye. The variation simulation utilizes a virtual assembly model, with all mating conditions defined, together with distributions on all inputs in locating schemes. The method may capture non-linearity, and allows any kind of distributions of input parameter variation. The variation simulation predicts, among other things, the expected mean value, standard deviation, range, and capability indices for the specified critical dimensions on the basis of the number of Monte Carlo iterations.

The purpose of a locating scheme is to lock a part or subassembly to its six degrees of freedom in space. A number of different locating schemes exist and are used in various industrial situations. In the context of a guided surgery simulation presented here, the following system is used: three primary locating points (A1, A2 and A3) control three degrees of freedom and lock the object to a plane, translation in Z (TZ), rotation around X (RX) and another around Y (RY). The two secondary locating points (B1 and B2) control two degrees of freedom, locking the object to a line, translation in X (TX) and rotation around Z (RZ). The last, tertiary locating point controls one degree of freedom, translation in Y (TY), as illustrated in FIG. 15. Three locating points are used several times. This is, for example the case here, namely point group 1: (A1, B1, C1), point group 2: (A2, B2), and point group 3: (A3), as illustrated in FIG. 10. The orthogonal 3-2-1 locating system is the most frequently used locating systems. However, other non-orthogonal systems exist and may also be used in other embodiments.

In embodiments, the variation simulation is the foundation and first step of totally three steps used in the analysis for predicting the foci for process optimization.

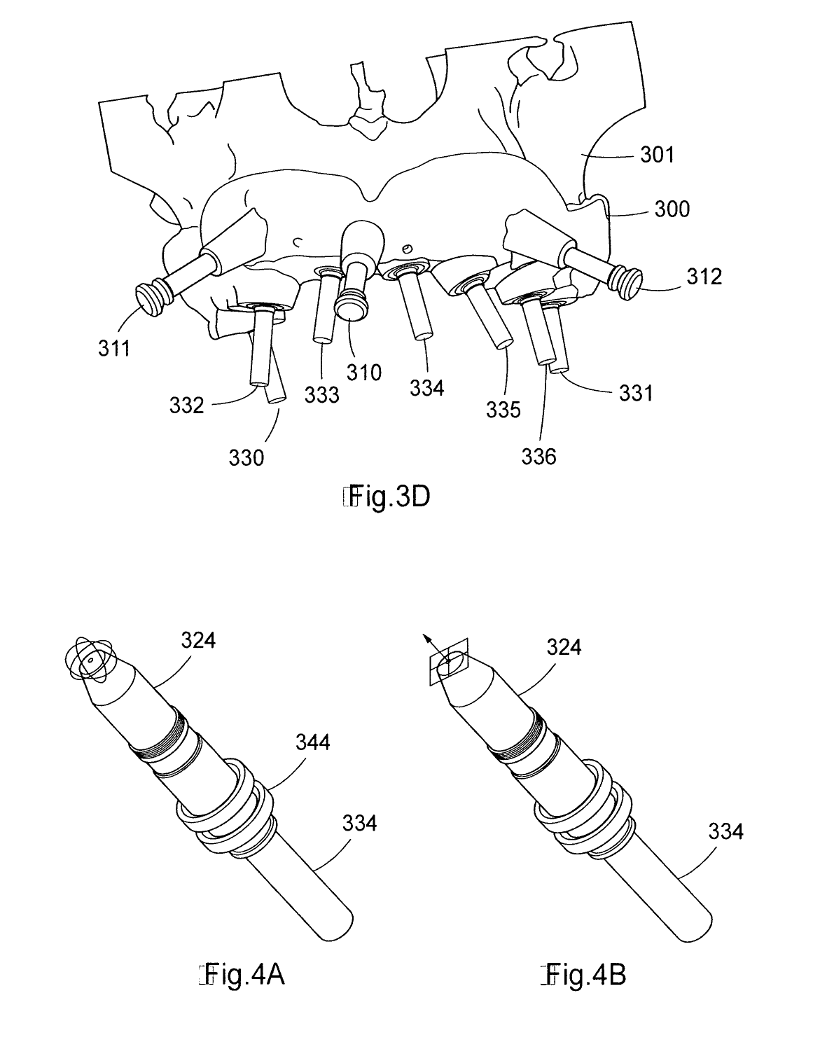

In a non-limiting example a range of the variation of an apical part of a dental implant was found to have a maximum deviation of an actual value from a planned value between 0.174-1.440 mm, see Table 0 below. The most critical product dimension in the example was defined at the apical part of the fixture, see FIGS. 4A and 4B. The reason that the most critical product dimension was defined at the apical part of the fixture is that this portion of the fixture penetrates foremost into place in the patient. Any sensitive objects, such as blood vessels or nerves would have been penetrated by the apical part of the fixture during assembly in the patient. With regard to patient safety, nerves and sensitivity of the intersection through bone surface are important factors to take into consideration during planning of a surgical template based dental drill guided and/or implant guided surgery.

A variation simulation is performed that simulates assembly of the parts of a guided surgery in the same order as the real guided surgery then subsequently may be performed comprising a medical product. For instance, for a surgical template based dental drill guided and/or implant guided surgery, the assembly process may be simulated in the order of: providing a surgical template, fixation of the surgical template in the oral cavity of the patient, drilling of holes using the drill guides of the surgical template, and installing the implants in the drilled holes using the guide sleeves of the surgical template.

The result of a surgical template based dental drill guided and/or implant guided surgery was predicted using the RD&T software of RD&T Technology AB, Mólndal, Sweden. A variation analysis was performed with approximately one hundred thousand Monte Carlo iterations performed. The critical product dimension was defined at the apical part of the fixture, see FIGS. 4A and 4B. FIGS. 4A and 4B are schematic illustrations of spherical or planar variance simulations of a Monte Carlo simulation;

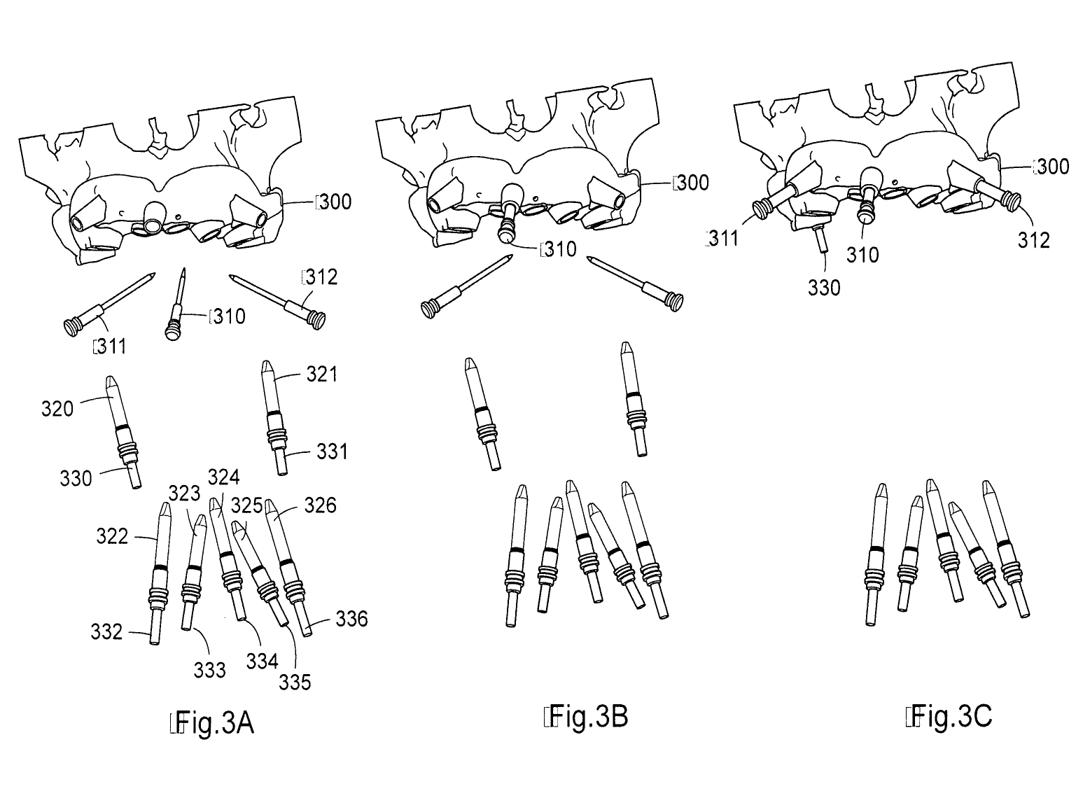

FIG. 3 is a flow chart illustrating a method according to an embodiment.

The method is a computer-implemented method comprising virtual planning of a medical procedure of a patient, which medical procedure comprises an assembly process; and generating data based on said virtual planning, wherein said data is configured for subsequent use in production of a medical product, which medical product is devised for use in said medical procedure, and/or for controlling a device configured to facilitate said medical procedure; and variation simulating at least a virtual assembly process at least partly corresponding to said assembly process of said medical procedure. The method 20 starts with

1. a first step 100 performing a variation simulation of an assembly process of a medical procedure, according to the Monte Carlo simulation method described above.

2. Secondly, the method comprises a step 110 comprising carrying out a sensitivity analysis, based on the result of the variation simulation performed in step 100. More precisely, a variation simulation of the assembly process of a medical procedure is executed with equal tolerances of +/−1, normally distributed for each parameter contributing with a tolerance to the assembly process.

This sensitivity analysis may reveal the most sensitive product parameters in the design concept onto which the medical procedure and the medical products or related products are based.

In order to optimize the design concept, the latter may be re-designed based on the result of this sensitivity analysis. For instance, the most sensitive product parameters may be prioritized when re-designing the design concept, for instance in order to improve the reliability and/or robustness thereof. For instance tolerances of tools, devices, or systems used for providing in data from a patient; machining tolerances for at least partly producing a medical product for use in a medical procedure; orders of an assembly process of a medical procedure; etc. may be changed based on the output of the sensitivity analysis.

3. Thirdly, the method comprises a step 120 comprising executing a contribution analysis with mated tolerances mapped out from each source in the process, as explained above with reference to design dependency matrices.

This step 120 may provide the greatest contributor to the final geometrical variation of the assembly of medical products when the assembly process of the medical procedure is completed. Hence, this contribution analysis may provide where to set the primary foci of an assembly process optimization. For instance, the largest contributor to final geometrical variation may be prioritized when re-designing the assembly process, for instance in order to improve the reliability and/or robustness thereof.

In summary, based on the results of the sensitivity analysis and the contribution analysis performed on the results of the variation simulation, a decision as to where to set focus for process optimization may be made, with the most geometrical variation contributing parameter and the most sensitive parameters as input variables. This is provided in a virtual environment.

Below this method is illustrated by means of an example, namely a surgical template based dental drill guided and/or implant guided surgery for a Maxilla including three anchor pins and seven implants.

The assembly, i.e. the surgical template based dental drill guided and/or implant guided surgery, includes drilling bores for fixtures and inserting the fixtures in jaw bone tissue. This is guided by a patient specific surgical template, which for instance is produced by rapid prototyping methods and thus a mass customized industrially manufactured medical product related to a medical procedure. The simulation model determines the final position of the implants when implanted. The critical product dimension in this embodiment is defined at the apical part of the fixture.

The variation simulation is based on the variation contributors presented in FIG. 1, described above. The variation simulation comprises repeating a virtual assembly process that simulates the assembly process of the medical procedure (in the example of a surgical template based dental drill guided and/or implant guided surgery) in the same order as the subsequent real medical procedure will be performed. The assembly order repeated in the variation simulation is the following for the example of surgical template based dental drill guided and/or implant guided surgery, with reference to the illustrations in FIGS. 3A to 3D:

1. The assembly process starts with positioning the surgical template 300 in the oral cavity of the patient, on the jaw of the patient. The accuracy of the position is determined by process parameters related to the examination of patient group—see FIG. 3A;

2. Then the surgical template is fixed on the jaw, e.g. by means of at least one anchor pin 310, 311, 312. The accuracy of the positions of the anchor pins 310, 311, 312 and dental implants 320, 321, 322, 323, 324, 325, 326, are determined by parameters of the part variation, design concept, examination of patient and assembly variation—see FIG. 3B, where a first anchor pin 310 is installed; dental implants 320, 321, 322, 323, 324, 325, 326 are shown with insertion tools 330, 331, 332, 333, 334, 335, 336, respectively inserted into a connection interface of the dental implant. The insertion tools 330, 331, 332, 333, 334, 335, 336 are removed after completed surgery. Also, guide sleeves are illustrated in the figures as “attached” to the dental implant and insertion tool. These guide sleeves are illustrated in this way only for illustrative purposes, and one example is shown in FIG. 4A, a guide sleeve 344. The guide sleeves are in reality assembled in and affixed to the surgical template and provide a direction and position for surgical drills and dental implants.

3. Next, the implants are installed. The implant positions are determined by the surgical template position and the Part variation—see FIG. 3C; a) The installation of the implants comprises firstly assembling, two implants, e.g. the outermost two implants 320, 321, fixed in the patient. The holes for these two implants are drilled, guided by means of the surgical template 300, whereupon the two implants are inserted into these holes, also guided by the surgical template 300. The surgical template 300 is then locked to these two implants 320, 321, each by means of a guided template abutment. The guided template abutments provide a fixed relation of the surgical template with reference to the jaw bone of the patient. In this manner these two implants 320, 321 prevent the surgical template 300 from moving in the axial implant direction. However, a small axial movement of the surgical template 300 still might occur. Therefore, an axial tolerance is also considered in the variance simulation as an input parameter; b) Next, the remaining implants 322-326 are installed. For this purpose, holes for the remaining dental implants are drilled, guided by the surgical template 300. Then the remaining dental implants 322-326 are inserted into these holes.

4. The variation simulation is accomplished, see FIG. 3D showing the final result of the medical procedure presently regarded;

5. Then a sensitivity analysis is performed; and

6. A contribution analysis is performed.

The variation contributing groups interact with each other in a complex way. This means that the final variation depends on the relationship between the input parameters. Each input parameter influences the final geometry and variation of the assembly of the implants. Therefore, a contribution analysis is performed after the variation simulation.

The results of the surgical template based dental drill guided and/or implant guided surgery of the example were predicted with RD&T. One hundred thousand Monte Carlo iterations were used for both calculations. The results are presented as the standard deviation in millimeters, regarding displacements with respect to nominal planning, where the critical product dimension is defined at the apical part of the fixture and is presented in Table 0.

TABLE 0
Results from variation simulation an example of a virtual
assembly process in a Maxilla

| Measure (Std) | Implant₁ | Implant₂ | Implant₃ | Implant₄ | Implant₅ | Implant₆ | Implant₇ |
|---|---|---|---|---|---|---|---|
| X (mm) | 0.650 | 0.927 | 0.681 | 0.809 | 0.679 | 0.934 | 0.650 |
| Y (mm) | 0.178 | 0.410 | 0.518 | 0.291 | 0.454 | 0.277 | 0.174 |
| Z (mm) | 1.000 | 1.430 | 0.992 | 1.210 | 1.020 | 1.440 | 1.000 |

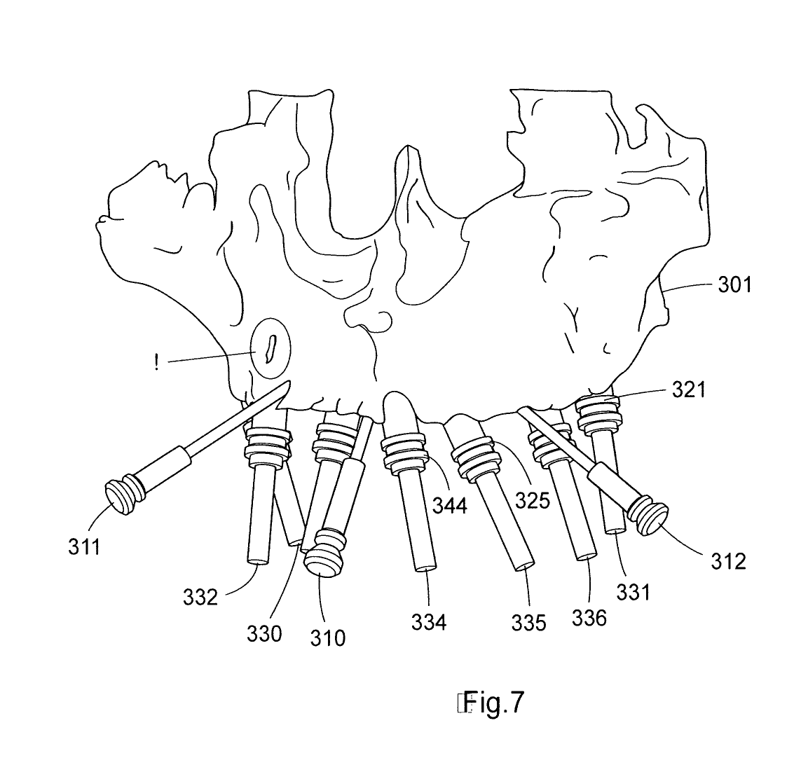

Table 0 presents the results given from the calculations. FIG. 7 presents a visual result of the variation simulation performed in the above example. The implants are numbered from the left to the right. A verification of the assembly process may be performed by visually analyzing the result given in FIG. 7. By analyzing FIG. 7, it was found that implant number two may intersect the bone surface of the Maxilla 301, denoted by the “!” in the Figure. Alternatively, or in addition, suitable surface detection algorithms may be used to detect such possible, but not desired, penetrations. In this manner also penetrations of other anatomical structures may be detected. In addition to penetration of bone surfaces, penetration of nerves or blood vessels may for instance be detected and hence corrected by a re-design.

A re-design may be performed for corrective purposes of such undesired penetrations in two ways: a) by reorientation of the implant or b) by manipulating the anchoring system. The second solution affects the whole design, and is preferable if the design concept allows a modification thereof. Otherwise, the issue is solved by reorientation of the implant, i.e. a re-planning of the installation of the dental implants.

After re-design, a virtual simulation of the assembly process of the re-designed guided surgery may be performed anew. Thus, verification that the re-design has been successful may be provided, or alternatively, further redesigns may be performed.

Verification of a virtually planned design or medical procedure, as described herein, provides improved safety and/or reliability of the medical procedure. The robustness of a design concept of a medical procedure, or a medical product related thereto, may be improved and/or optimized.

Because a virtual prediction of the result may be done, an improvement and/or optimization of the pre-planned surgery may be made as well. For instance, the virtual result of a pre-planned surgical template based dental drill guided and/or implant guided surgery, may be improved and/or optimized by manipulating a anchoring system to be used in the guided surgery. In this manner a more robust design of the surgical template may be achieved, which means that a higher degree of safety can be added to the medical procedure, before it is actually performed.

Another benefit is that a virtual planning of a medical procedure now may be provided for patients suffering from certain diseases, which hitherto made a virtual planning of medical procedures practically less advantageous. For instance patients that suffer from diseases that lead to great bone loss, e.g. due to bone cancer that has surgically been removed, may undergo verified, pre-secured dental surgery, with increased patient safety thanks to methods according to the present invention. This is enabled by the above described variation simulation. One benefit of suppressing geometrical variation is thus that more complex medical procedures may be performed. In other words, if the process related to the medical procedure is optimized regarding geometrical variations, more complicated surgeries may be performed than previously possible.

Furthermore, the variation simulation may also be used for a contribution analysis and stability analysis of the assembly process, as well as the final result of a medical procedure. A contribution analysis and a stability analysis may be performed for providing data to be used in a re-design of the design concept or assembly process of a medical procedure.

In a design concept or assembly process of a medical procedure the greatest allocated tolerances in the design concept or the assembly process may not necessarily contribute with the greatest variation to the final result thereof. By performing a process optimization based on the most critical product parameters, the robustness of the design concept may be improved, thus increasing patient safety.

The contribution analysis will now be described.

For the variation simulation, pre-defined tolerances may be used as input parameters. In addition, or alternatively, tolerances used as input parameters for the variance simulation may be provided in other ways, e.g. by measurements, empirically or as feedback from results of previous medical procedures, i.e. deviations from planned implantations to results of subsequent, real implantations, etc.

The analysis for predicting the greatest variation contributor may be performed in two steps.

First, a variance simulation is performed using equal tolerance distribution. Equal tolerance distribution implies that each input parameter of the assembly process of the medical procedure is assigned the same, identical, tolerance, such as ±1. This analysis method captures each component's contribution at the pre-defined critical measure at the apical part of the fixture, dimensionless. The uniform tolerance calculations analyze the concept itself and provide an evaluation thereof. This first step is also called sensitivity analysis.

Secondly, a variance simulation is carried out by using unique tolerances for each input parameter, considering both manufacturing and assembly, wherein the results are depending on the unique tolerances. This analysis method captures each input parameter's contribution to the critical product dimension regarding unique tolerance. With the help of the results from this second calculation, using unique tolerances, a conclusion of the foci can be drawn, i.e. which input parameters or steps of the medical procedure contribute to which degree to the overall variation of the final result—such as implanted fixtures in a patient. This second step is also called contribution analysis.

The following tables show results of sensitivity analyses and contribution analyses performed on the Maxilla example mentioned above. An analysis of the results shown in the tables is given further below.

Table 1 shows the result of sensitivity analysis using an equal tolerance distribution, and Table 2 shows the result of a contribution analysis using a unique tolerance distribution. Both tables are based on the variance simulation performed for the upper jaw (Maxilla) example described above, for instance with reference to FIGS. 3A-3D. The results are summarized and presented with each component defined in their acting group in the process: Assembly variation (Surgery), Part variation, and Examination of patient.

TABLE 1
Sensitivity analysis. Equal tolerance distribution, Maxilla

| Activity | Contribution |
|---|---|
| Assembly variation (Surgery) | 48.3% |
| Part variation | 45.0% |
| Examination of patient | 6.7% |

It can be seen from Table 1 that a result from the performed sensitivity analysis is that the assembly variation is the most sensitive parameter, followed by the variation of the medical products and related products to be used in the dental restorative procedure, wherein the examination of the patient only contributes to a minor part.

TABLE 2
Contribution analysis. Unique tolerance distribution, Maxilla

| Activity | Contribution |
|---|---|
| Assembly variation (Surgery) | 37.9% |
| Part variation | 31.1% |
| Examination of patient | 31.0% |

It can be seen from Table 2 that a result from the performed contribution analysis is that the assembly variation is the largest contributor to the overall tolerance of the final result of the virtually simulated assembly process, followed by the variation of the medical products and related products to be used in the dental restorative procedure, wherein the examination of the patient only contributes to a minor part.

The sensitivity analysis with uniform tolerance distributions tells that the Assembly variation and Part variation are significantly more sensitive to the final variation than the Examination of the patient.

The background to this is that the parts within the two first mentioned groups of the above tables (Assembly variation and Part variation) often depend on a geometrically smaller assembly system (locating system where the individual locating points are close) compared to the examination of the patient. One example, for instance, is that the drill is guided by a sleeve, which in itself is mounted at the drill- and implant-guide (surgical template), which in itself is secured to the jaw by anchor pins. This means that there are several relatively small assembly systems guiding the drill, namely the sleeve of the surgical template and the anchor pins determining the position of the surgical template in the oral cavity. Thus, the direction and depth of a drill is determined by these assembly systems (sleeve and anchor pins).

A typical antagonism to the case of using anchor pins to fix the surgical template to the jaw is when the surgical template is positioned directly on the jaw and only held in position by a tight fit, e.g. to existing teeth in the oral cavity. In this case the whole occlusion area determines the assembly system (locating system where the individual points are relatively far from each other). Hence, the assembly system is relatively large for this case and the sensitivity contribution is consequently lower.

An optimization of the results from the sensitivity analysis means that the concept itself may need to be redesigned. If this re-design based on the results of the sensitivity analysis is done, the concept converges towards a less sensitive concept.

When optimizing the actual variation, the focus should also be set on the Assembly group. The background to this is that the design concept is very flexible and adaptable to a wide range of patient situations. However, due to this flexibility of design concept, it is relatively sensitive, and for example a close fitted anchoring system contributes to the final variation more than a relatively large anchoring system, a clear relationship between the cause and effect can be shown.

Based on these variation simulation results, a variation suppressing optimization of medical treatments may be performed. Having the greatest variation contributor in mind, a focus may be set where attention is most needed, and eventually this will lead to a higher degree of patient safety.

The results of the above described example for variation simulation of two dental drill guided and/or implant guided surgeries is as follows. The variation simulation of the Maxilla dental restoration needed an optimization of the implant positions before the surgery in order to provide a safe surgery. By analyzing the results, it was also found that the plan could be optimized in order to minimize the geometrical variation. Thus, the method is suitable for predicting guided surgeries to achieve safer treatments.

The above elucidated principles including variation simulation may also be applied to the planning of other dental restorative procedures, for instance copings on dental preparations, bridges, planning of ceramic dental products, such as a single tooth, etc. Moreover, functional surfaces may be verified by the same principles.

Furthermore, combinations of dental products may be verified, e.g. an occlusion line of dental restorations.

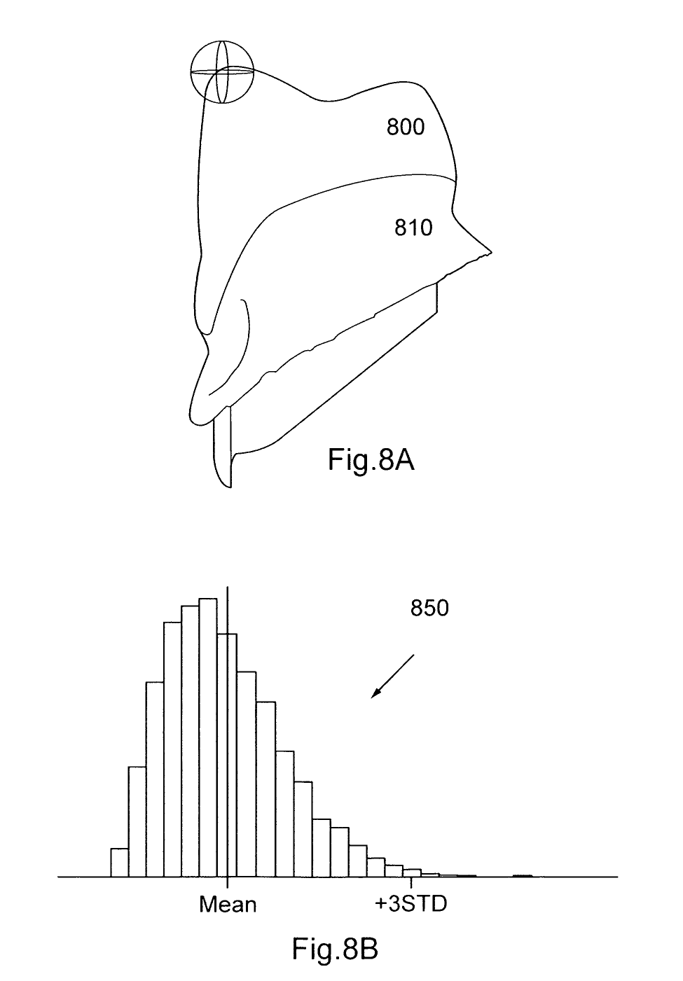

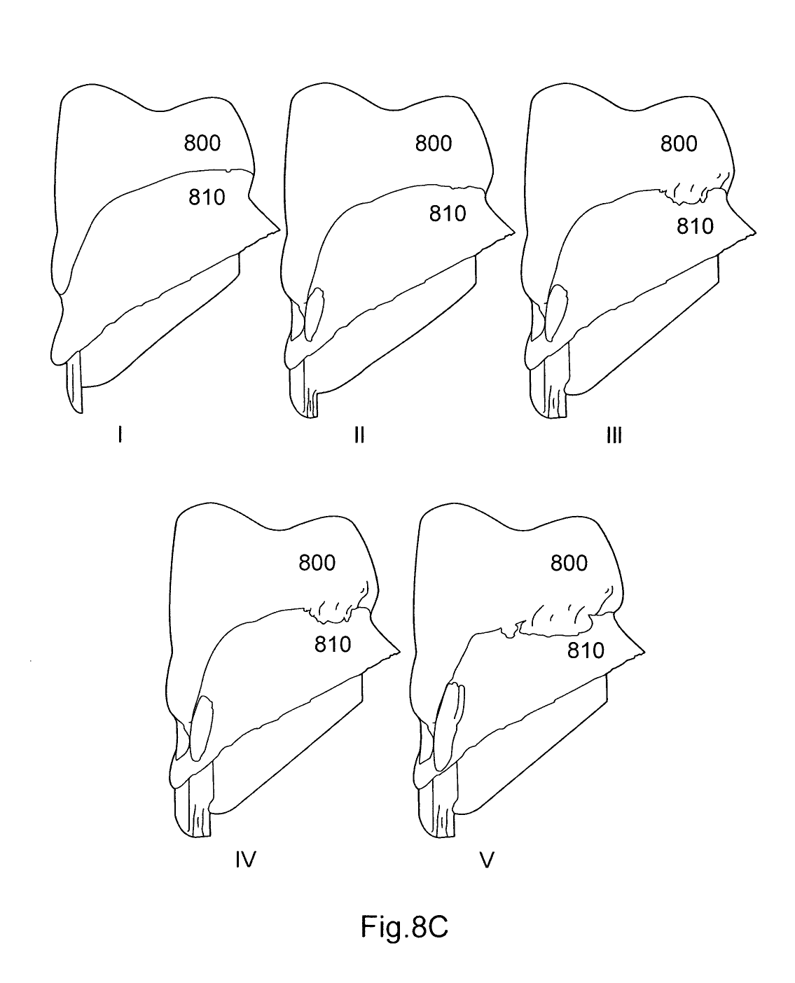

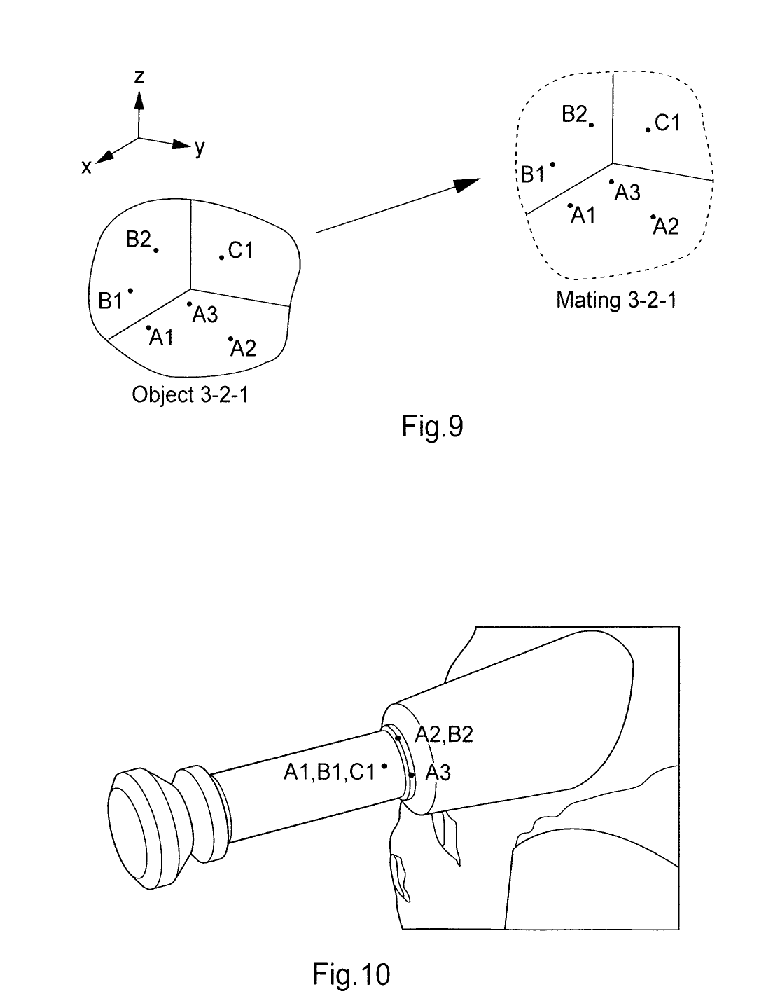

FIGS. 8A and 8C are illustrations of a variation simulation of a planning of a dental restoration comprising a coping 800 on a dental preparation 810, wherein FIG. 8C is a schematical illustration showing increasing numbers (from i, ii, iii, iv, to v) of Monte Carlo variance simulations of positions of the coping of FIG. 8A.

FIG. 8B is a graph showing a statistical variance distribution 850 of a point of the coping of FIG. 8A.

When virtually planning the form of a coping, one or more critical product dimensions are assigned to the coping. The critical product dimensions may for instance comprise a point at the outside of the coping, or a point on the inside of the coping.

A point on the outside of the coping may be a critical product dimension due to adjacent teeth in the same jaw as to which the coping is to be affixed, e.g. by means of a preparation of an existing tooth of the patient, or a dental implant. The coping should not have an extension such that it collides with adjacent teeth.

However, a coping may be produced that does not fit into place, e.g. due to manufacturing tolerances. This may be detected and thus avoided by means of a variation simulation of the assembly process of the coping in the oral cavity, e.g. taking into consideration adjacent teeth, a shape of a connection interface of a preparation or dental implant, and/or the specific way of mounting of the coping to the connection interface.

A point on the inside of the coping may be a critical product dimension, as it may determine the fit of the coping to the connection interface of the dental implant or the dental preparation. The coping may for instance be adjusted to have a certain amount of friction, such that it fits to the dental preparation without loosening. In this case, two points on the interior of the coping may be generated for virtually checking if the coping fits across a preparation line.

The assembly process that is variation simulated may comprise repeatedly putting the coping onto a dental preparation. This variation simulation creates a volume of the coping due to the tolerances of the product assembly process. This volume may be used for verifying the planning of the assembly of the coping in the oral cavity. For instance, it may be checked if the volume of the coping, derived from the variation simulation collides with adjacent teeth or if it does not match the occlusion line when assembled.

As can be seen in FIG. 8C, with increasing numbers of iterations in the variance simulation, the margin of the coping 800 may be misaligned in relation to the preparation line of the dental preparation 810. Here, a re-design of the coping 800 or its manufacturing process is recommendable, which may be made according to the methods above, e.g. performing a sensitivity analysis, a contribution analysis, and verification of the designs concept and/or assembly process.

Other medical procedures comprising medical products may also be verified by means of the above elucidated principles including variation simulation, as for instance hip implants, knee joint implants, artificial or replacement vertebrae, artificial shoulder implants, artificial joint replacement implants, or in various other medical treatments, such as within framebased or frameless stereotactic surgery.

In summary, the robustness of a medical procedure and a related design concept of medical products related thereto may be improved by means of the methods comprising variation simulation described herein.

The results of variation analyses may provide guidance in the pre-planning of a medical treatment, which may provide even further increased process stability and patient safety.

The result of a contribution analysis may be used to provide an indicator during virtually planning the medical procedure. For instance, when virtually planning a guided dental surgery, the positions of implants in bone tissue of the craniofacial area is determined. Based on this planning, a surgical template is produced, which then is used during the medical procedure. The variance analysis described above may be performed during the step of virtual planning. It may be calculated in the background or upon reguest, e.g. when the virtual planning is about to be terminated.

The result of the variance analysis and the contribution analysis may be presented as an indicator allowing verifying the robustness of the real medical procedure to be performed and the result thereof. For instance, long term stability of implants may be improved, which are implanted by means of a surgical template which is produced after a robustness check according to the above methods.

Alternatively, or in addition, products may be specified that have a higher variance contribution than others. Thus these specified products may be changed in order to achieve a more advantageous contribution to the final result of the medical procedure.

Alternatively, or in addition, products may be identified that have a higher variance contribution than others. These products may automatically or semi-automatically be adjusted within the planning according to defined rules. E.g. a position of an implant may be automatically adjusted depending on closeness to bone surface borders, nerve channels, blood vessels, etc. When this adjustment is made a new run of variance analyses may be initiated in order to iteratively improve the planning of the medical procedure and to improve robustness thereof.

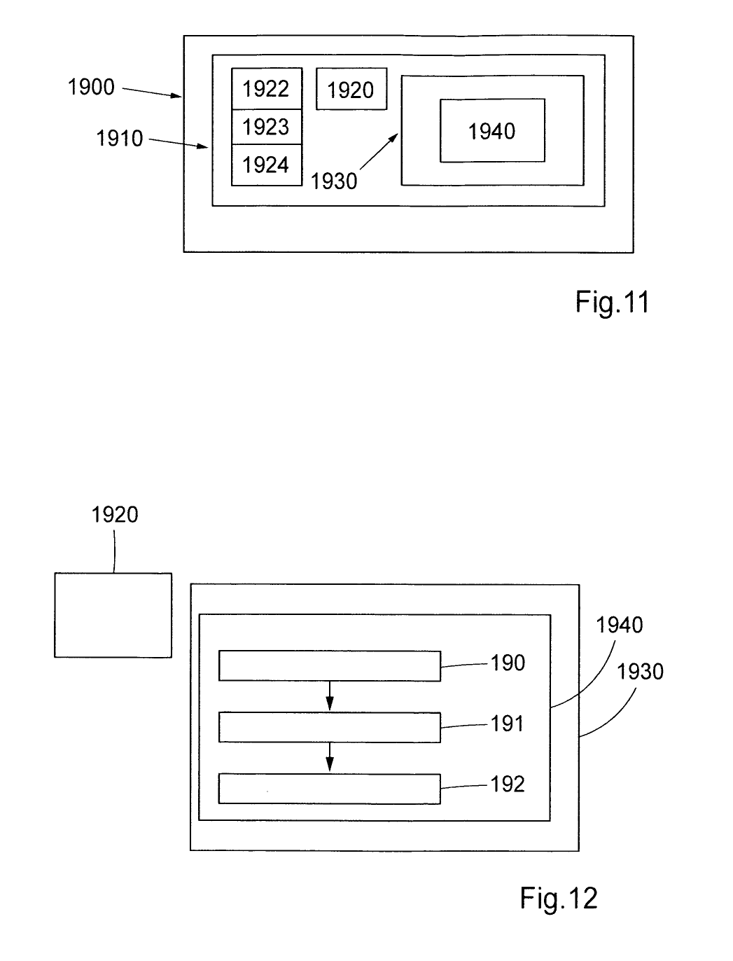

An embodiment for a system for performing the above described method is schematically illustrated in FIG. 11. FIG. 12 is a schematic illustration of a computer program according to an embodiment.

A presurgical planning of the medical procedure may be performed virtually in a computer based environment. Embodiments of the present invention may provide a verification or improvement of such a presurgical planning. The presurgical planning may be made automatically or in an interactive way with a user. Planning of the dental restoration may in the latter case be made visually on a display of a medical workstation, e.g. of the system described below with reference to FIG. 11, in an interactive way manipulated by user input. For instance the position and direction of dental implants in jaw bone is virtually presented on the display visualizing the jaw bone structure where a dental restoration is to be made. During planning care has to be taken that for instance no nerves are damaged or that the dental implant is positioned in as much dense bone as possible, in order to ensure a successful surgical installation of the dental implant.

Hence, the user may virtually manipulate or accept placement of dental implants in advance of final placement. The implant's position, angulation, type of implant, length, in relation to final teeth restoration, may in an interactive manner be manually fine tuned.

When the implant is positioned, a fixed outer boundary surface of the implant, or a boundary surface of an abutment that is attached to the implant, is determined. Now the intermediate structure between the implant and the veneering will be provided in order to finalize planning of the dental restoration.

The system 1900 provides computer-based planning of a dental restorative procedure of a patient having a craniooral space, and/or of at least one dental component for a dental restorative procedure.

The system 1900 comprises a unit 1922 for virtual planning of a medical procedure of a patient, which medical procedure comprises an assembly process; and a unit 1923 for generating data based on said virtual planning, wherein said data is configured for subsequent use in production of a medical product, which medical product is devised for use in said medical procedure, and/or for controlling a device configured to facilitate said medical procedure; and a unit 1924 for variation simulating at least a virtual assembly process at least partly corresponding to said assembly process of said medical procedure.

A medical workstation 1910 comprises the usual computer components like a central processing unit (CPU) 1920, memory, interfaces, etc. Moreover, it is equipped with appropriate software for processing data received from data input sources, such as data obtained from CT scanning or 3D scanning. Software may for instance be stored on a computer readable medium 1930 accessible by the medical workstation 1910. The computer readable medium 1930 may comprise the software in form of a computer program 1940 comprising suitable code segments 190, 191, 192 for performing a variation simulation. The medical workstation 1910 further comprises a monitor, for instance for the display of rendered visualizations, as well as suitable human interface devices, like a keyboard, mouse, etc., e.g. for manually fine tuning the automatical planning otherwise provided by the software. The medical workstation may be part of the system 1900. The medical workstation may also provide data for producing at least one of a dental restoration and a product related to the dental restorative procedure.

For planning, patient data, e.g. from a CT scan, is imported into a software for pre-surgical planning of dental restorative procedures, for instance run on the medical workstation 1910. The medical workstation 1910 may have a graphical user interface for computer-based planning of a dental restorative procedure of a patient having a craniooral space, and/or of at least one dental component for said dental restorative procedure. The graphical user interface may comprise components for visualizing the method described above in this specification or recited in the attached claims.

The computer software comprises a first code segment 190 for virtual planning of a medical procedure of a patient, which medical procedure comprises an assembly process; and a second code segment 191 for generating data based on said virtual planning, wherein said data is configured for subsequent use in production of a medical product, which medical product is devised for use in said medical procedure, and/or for controlling a device configured to facilitate said medical procedure; and a third code segment 192 for variation simulating at least a virtual assembly process at least partly corresponding to said assembly process of said medical procedure.

A result of a variation simulation of a medical procedure may be provided to a user in a graphical user interface on the medical workstation 1910. Regions with different variances of an assembly process or sub-assembly thereof may be provided. For instance, the end assembly according to the variance simulation of an assembly process of a medical procedure may be provided as a color coded image, e.g. on the screen of the medical workstation. The color coding may for instance be based on a deviation relative a predefined normal variance.

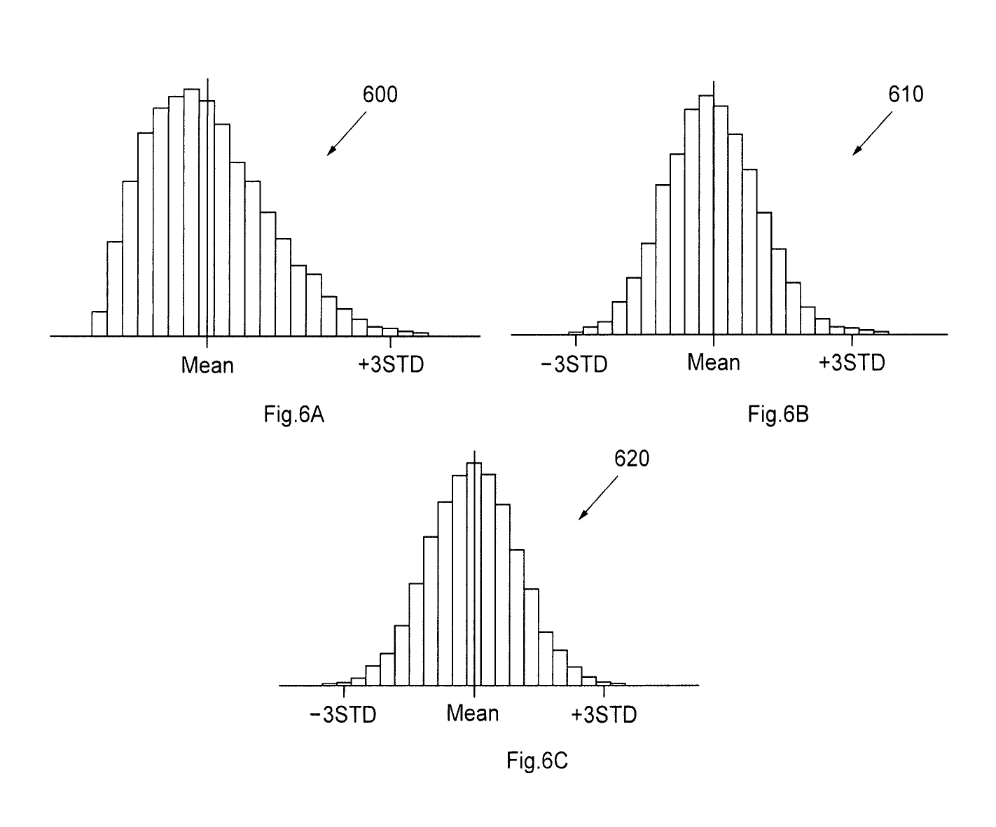

In addition, or alternatively statistical data may be shown for selected portions of the medical products of the medical procedure, such as the statistical distributions shown in FIGS. 6A to 6C. Such portions may be user selectable, e.g. via the graphical interface and human interface devices.

Other results of the run variance simulations that may be provided additionally, or alternatively, are for instance the number of runs of the MonteCarlo simulation; the mean value of the deviations of the product parameter; a standard deviation, a minimum value, a maximum value, a relative maximum, a relative minimum, a range of the product parameter, etc.

FIG. 6A is a graph in a schematic illustration showing a statistical variance distribution 600 that was obtained from the apical part of a selected dental implant of the example described above and shown in FIG. 3D. The statistical distribution shown in the graph of FIG. 6A refers to statistical variance distribution of this apical part in x-direction. It can be seen that the distribution is shifted to the left. This sloping may be an indication that the implant is influenced in this direction, e.g. by a nearby anchor pin that is positioned too close relative the dental implant.

Information from statistical distributions of variances, derived by variance simulation of an assembly process of a medical procedure, may thus be processed for re-designing the medical procedure. In this case, for instance, the implant or anchor pin may be re-located based on the statistical result, e.g. the implant to the right or the anchor pin to the left relative each other. Then a new variance distribution may be run to verify the effect of this re-design.

FIG. 6B is a graph of corresponding to that in FIG. 6A, but in y-direction. More precisely, a statistical variance distribution 610 is shown that was obtained from the apical part of the selected dental implant of the example described above and shown in FIG. 3D. This distribution is, in comparison to that shown in FIG. 6A, more normally distributed around a mean value. In the example, this indicates that the dental implant has a satisfactory positioning in depth.

FIG. 6C is a graph corresponding to that in FIG. 6A, but in z-direction. This distribution 620 is, as that shown in FIG. 6B, substantially normal distributed around a mean value. In the example, this indicates that the dental implant has a satisfactory distribution in the z-direction.

The data that is generated based on the virtual planning may also be used to control a robot performing the medical procedure.

As will be appreciated by one of skill in the art, the present invention may be embodied as device, system, method or computer program product. Accordingly, the present invention may take the form of an entirely hardware embodiment, a software embodiment or an embodiment combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

The present invention has been described above with reference to specific embodiments. However, other embodiments than the above described are equally possible within the scope of the invention. Different method steps than those described above, performing the method by hardware or software, may be provided within the scope of the invention. The different features and steps of the invention may be combined in other combinations than those described. The scope of the invention is only limited by the appended patent claims.

1. A computer-implemented method comprising
virtual planning of a medical procedure of a patient, using a computer system, which medical procedure comprises an assembly process; and
generating data based on said virtual planning, using a computer system, wherein said data is configured at least
for subsequent use in production of a medical product, which medical product is devised for use in said medical procedure, or
for controlling a device configured to facilitate said medical procedure; and
variation simulating, using a computer system, at least a virtual assembly process at least partly corresponding to said assembly process of said medical procedure.

2. The method according to claim 1, further comprising using a result of said variation simulation for a process optimization of a design concept of said medical procedure or for a re-design of said virtual assembly process.

3. The method according to claim 2, further comprising performing a sensitivity analysis, for identifying sensitive product parameters in said design concept onto which the medical procedure and the medical products or related medical products are based, and for said process optimization of said design concept of said medical procedure.

4. The method according to claim 3, wherein said performing said sensitivity analysis comprises performing said variation simulation using an equal tolerance distribution for input parameters of said variation simulation of said assembly process.

5. The method according claim 1, further comprising
performing a contribution analysis of input parameters of said assembly process, comprising
identifying an input parameter having the largest geometrical variation contribution to a final geometrical variation of said assembly process; and
determining an optimization of said assembly process based on a modification of said input parameter having the largest geometrical variation contribution.

6. The method according to claim 5, wherein said performing said variance simulation is carried out by using unique tolerances for each input parameter of said variation simulation.

7. The method according to claim 1, said virtual planning of said medical procedure comprising customizing said medical product for said patient, said method further comprising using a result of said variation simulation for verification of said virtual assembly process of said customized medical product in said medical procedure.

8. The method claim 1, further comprising verification of said planning of said medical procedure based on said variation simulating, and re-planning said medical procedure based on the result of said verification.

9. The method claim 1, wherein said assembly process comprises virtually replacing a body part with said medical product, virtually temporarily anchoring said medical product to an existing body portion, or virtually fixating said medical product to an existing body portion.

10. The method according to claim 1, wherein virtual planning comprises virtually planning a guided surgery.

11. The method according to claim 10, wherein virtually planing said guided surgery comprises virtual planning of surgical template based dental guided surgery.

12. The method according to claim 10, wherein virtually planing said guided surgery comprises virtual planning of framebased stereotactic surgery.

13. The method according to any of claim 1, wherein said assembly process comprises replacement of a hip joint with a hip prosthesis.

14. The method according to any of claim 1, wherein said assembly process comprises bone grafting.

15. The method according to any of claim 1, wherein said assembly process comprises assembling of knee joint implants, artificial or replacement vertebrae, artificial shoulder implants, artificial joint replacement implants, or maxillofacial reconstructions.

16. The method according to claim 1, comprising identifying a plurality of product parameters that affect a final result of said assembly process and assigning each of said identified product parameters a tolerance.

17. The method according to claim 1, wherein said variation simulation comprises iteratively repeating said virtual assembly process of said medical procedure.

18. The method according to claim 1, wherein said variation simulation is Monte Carlo based simulation.

19. The method according to claim 1, further comprising performing a statistical analysis of a result of said variation simulation.

20. The method according to claim 1, wherein said medical product is a surgical template comprising a sleeve for receiving a surgical drill.

21. The method according to claim 1, wherein said medical product is a dental implant.

22. The method according to claim 21, wherein said dental implant has the form a root of a tooth.

23. The method according to claim 1, wherein said generating data is a function of said planning of said medical procedure.

24. The method according to claim 23, wherein said medical product is a surgical template comprising a sleeve for receiving a surgical drill and wherein said data comprises data for production of said surgical template, said data comprising data for an orientation and position of said sleeve relative said surgical template as a function of a dental implant positioned during said virtual planning of said medical procedure.

25. The method according to claim 24, wherein said assembly process comprises
positioning said surgical template in an oral cavity of said patient;
affixing said surgical template to said patient by means of at least one anchor pin;
drilling at least one hole with a surgical drill guided by said sleeve;
inserting at least one dental implant into said at least one hole, guided by said sleeve.

26. The method according to claim 1, wherein said medical product is a coping and said assembly process comprises affixing said coping to a dental preparation or a dental implant connection interface.

27. A system for planning a medical procedure of a patient, said system comprising
a unit for virtual planning of the medical procedure of the patient, which medical procedure comprises an assembly process; and
a unit for generating data based on said virtual planning, wherein said data is configured at least
for subsequent use in production of a medical product, which medical product is devised for use in said medical procedure, or
for controlling a device configured to facilitate said medical procedure; and
a unit for variation simulating at least a virtual assembly process at least partly corresponding to said assembly process of said medical procedure.

28. A computer readable medium for planning a medical procedure of a patient, said computer-readable medium containing instructions, said instructions operable to execute on a computer system, said instructions when executing on the computer system performing a method comprising:
virtual planning of a medical procedure of a patient, which medical procedure comprises an assembly process; and
generating data based on said virtual planning, wherein said data is configured at least
for subsequent use in production of a medical product, which medical product is devised for use in said medical procedure, or
for controlling a device configured to facilitate said medical procedure; and
variation simulating at least a virtual assembly process at least partly corresponding to said assembly process of said medical procedure.

29. (canceled)

30. A medical workstation for comprising hardware configured to perform a method comprising:
virtual planning a medical procedure of a patient; and
generating data based on said virtual planning for subsequent use in production of a medical product devised for use in said medical procedure,
said medical workstation comprising
a unit for variation simulating a virtual assembly process of said medical procedure.

31. A computer-implemented method for planning a medical procedure of a patient, said method comprising:
presenting, using a computer system, a graphical user interface, on a display attached to the computer system, for virtual planning a medical procedure comprising a virtual assembly process of a medical product in said medical procedure,
said user interface comprising an indicator for the robustness of said assembly process.
